(19) United States
(12) Patent Application Publication
(10) Pub. No.: US 2002/0082801 A1
(43) Pub. Date: Jun. 27, 2002

(54) Shape measuring method, shape measuring unit, exposure method, exposure apparatus and device manufacturing method

(75) Inventor: Kenichi Shiraishi, Saitama (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Nikon Corporation, Tokyo (JP)

(21) Appl. No.: 10/026,686

(22) Filed: Dec. 27, 2001

(30) Foreign Application Priority Data
Dec. 27, 2000 (JP) 2000-396984

(51) Int. Cl. G01B 7/00; G01B 15/00; G06F 15/00

(52) U.S. Cl. 702/155

(57) ABSTRACT

A shape measuring method and unit measures position information, in a normal direction of the surface of the object W, of the surface of the object W along a plurality of paths which extend from a plurality of respective points Pn_{S} (n=1 through 4) on the surface of the object W outward from the object. As a result, for each of the plurality of paths a measurement waveform which varies characteristically on the boundary between a predetermined area and the other area is obtained. Subsequently, by analyzing the measurement results, boundary positions between the predetermined area and the other area are obtained, the number of the boundary positions being equal to that of the paths. And the shape of the predetermined area is determined based on the boundary positions obtained, and thus the shape of the predetermined area on the surface of the object W can be accurately measured.

### BACKGROUND OF THE INVENTION

1. Field of The Invention

The present invention relates to a shape measuring method, a shape measuring unit, an exposure method, an exposure apparatus and a device manufacturing method, and more specifically to a shape measuring method and shape measuring unit that measures the shape of a predetermined area on the surface of an object such as a substrate, an exposure method and exposure apparatus that uses the shape measuring method, and a device manufacturing method that uses the exposure method in a lithography process.

2. Description of the Related Art

In a lithography process for manufacturing semiconductor devices, liquid crystal display devices, or the like, various exposure apparatuses have been used. Recently, as, for example, an exposure apparatus for semiconductors, a reduced-projection exposure apparatus (a so-called stepper) of a step-and-repeat method that transfers a fine pattern formed on a photo-mask or reticle (both referred to as a “reticle” hereinafter) onto a semiconductor wafer or a substrate such as a glass plate (both referred to as a “wafer” hereinafter), which is coated with a resist, through a projection optical system and a scan-type projection exposure apparatus (a so-called scanning-stepper) of a step-and-scan method are mainly used, the scanning-stepper having been produced by improvement on the stepper.

The projection optical systems of these exposure apparatuses usually have a very shallow focus depth, and in order to avoid the effects of undulation and the like of a wafer, each shot area needs to lie within the focus depth of the optimum image plane of the projection optical system. For that purpose, the exposure apparatuses need to be so constructed that the position of the wafer in the optical axis direction and an inclination thereof can be adjusted. Therefore, a wafer stage usually comprises a table whose inclination and position in the optical axis direction of the projection optical system are adjustable and on which a wafer is mounted, and so-called focus-leveling is performed by driving the table via an auto-focus-leveling mechanism.

Such an auto-focus-leveling mechanism, as disclosed in, for example, Japanese Patent Laid-Open No. 6-283403, uses a multi-focal position detection system having a lot of position sensors, measures information (focus information) of the surface of each shot area of the wafer along the optical axis direction, and based on the measurement results, performs focus-leveling.

In performing focus-leveling using the multi-focal position detection system, different kinds of sensors are employed between shot areas for which detection points of all sensors are on almost flat resist surface portion having almost uniform thickness and which are on the inner portion of the wafer, and other shot areas for which some sensors are outside the resist surface and which are on the periphery of the wafer. The two kinds of sensors are switched depending on whether or not detection points of all sensors are in a focus-position-measurable area, where the resist surface is almost flat, and an optimum sensor for auto-focus-leveling is selected out of the sensors whose detection points are in the focus-position-measurable area.

In the prior art, the focus-position-measurable area is specified by, e.g., an operator inputting a distance from the wafer edge through the keyboard or the like, the distance being one between the wafer edge and the outer edge of the focus-position-measurable area. However, the shape of the focus-position-measurable area varies due to process bumps on the wafer periphery and dispersion of the width of the resist layer removed by rinsing. Therefore, an operator needs to input a distance specifying the shape of the focus-position-measurable area for each layer to the exposure apparatus. Thus, exposure cannot be performed efficiently.

### SUMMARY OF THE INVENTION

This invention was made under such circumstances, and a first purpose of this invention is to provide a shape measuring method and shape measuring unit that can accurately measure the shape of a predetermined area on the surface of an object.

A second purpose of this invention is to provide an exposure method and exposure apparatus that can efficiently perform highly accurate exposure.

A third purpose of this invention is to provide a device manufacturing method with which highly integrated devices having a fine pattern thereon can be manufactured.

According to a first aspect of this invention, there is provided a shape measuring method with which to measure a shape of a predetermined area on a surface of an object, the shape measuring method comprising: measuring position information, in a normal direction of the surface of the object, of the surface of the object along a plurality of paths which extend from a plurality of respective points on the surface of the object outward from the object; and calculating the shape of the predetermined area based on measurement results of the measuring.

According to this, position information, in a normal direction of the surface of the object, of the surface of the object is measured along a plurality of paths which extend from a plurality of respective points on the surface of the object outward from the object. As a result, for each of the plurality of paths a measurement result is obtained in which position information, in a normal direction of the surface of the object, of the surface of the object varies considerably and rapidly in positions where a large drop occurs such as a position on an outer edge of the resist layer formed by the rinsing (hereinafter, a “rinsed edge position”) and a position on the wafer edge. Subsequently, by analyzing the measurement results, boundary positions between the predetermined area and the other area are obtained, the number of the boundary positions being equal to that of the paths. And the shape of the predetermined area is determined based on the boundary positions obtained, and thus the shape of the predetermined area on the surface of the object can be accurately measured.

In the shape measuring method according to this invention, each of the plurality of paths may be a straight line.

Furthermore, the shape measuring method according to this invention may perform low-pass-filtering processing on each of waveforms which are measured along the plurality of paths in order to extract a low-frequency component, and may also perform differential processing on each of waveforms which are formed by the low-pass-filtering processing. Here, the differential processing may be second-order differential processing.

Furthermore, the shape measuring method according to this invention may perform differential processing on each of waveforms which are measured along the plurality of paths. Here, the differential processing may be second-order differential processing.

Moreover, in the shape measuring method according to this invention, the object may be a substrate of which a surface is coated with photosensitive material so as to form an almost flat layer. Here, “almost flat” means that considering the thickness of the coating photosensitive material, irregularity of the surface thereof is so small.

Here, part of the photosensitive material near an outer edge of the substrate may be removed. In this case, the predetermined area may be one of a whole area of the substrate and an area coated with the photosensitive material.

According to a second aspect of this invention, there is provided a shape measuring unit which measures a shape of a predetermined area on a surface of an object, the shape measuring unit comprising: a measuring unit which measures position information, in a normal direction of the surface of the object, of at least one point on the surface of the object; a drive unit which relatively moves the object and the measuring unit along a direction parallel to the surface of the object; and a processing unit which calculates the shape of the predetermined area based on results of the measuring unit measuring along a plurality of paths, which extend from a plurality of respective points on the surface of the object outward from the object, while the drive unit relatively moves the object and the measuring unit.

According to this, while a drive unit relatively moves the object and the measuring unit along a direction parallel to the surface of the object, a measuring unit measures position information, in a normal direction of the surface of the object, of the surface of the object along a plurality of paths which extend from a plurality of respective points on the surface of the object outward from the object. Subsequently, by analyzing the measured waveforms, boundary positions between the predetermined area and the other area are obtained, the number of the boundary positions being equal to that of the paths. And the shape of the predetermined area is determined based on the boundary positions obtained. That is, the shape measuring unit according to this invention can measure the shape of the predetermined area on the surface of the object, using the shape measuring method of this invention, and thus the shape of the predetermined area on the surface of the object can be accurately measured.

In the shape measuring unit according to this invention, the object may be a substrate of which a surface is coated with photosensitive material so as to form an almost flat layer.

According to a third aspect of this invention, there is provided an exposure method which forms a predetermined pattern on a substrate by illuminating the substrate with an exposure beam, the exposure method comprising: measuring a shape of a flat area of a surface of the substrate, using the shape measuring method of this invention; and detecting position information, in a normal direction of the surface of the substrate, of at least one point on the flat area of the surface of the substrate, which flat area is obtained from results of the measuring, and illuminating the substrate with the exposure beam while controlling at least a position, in the normal direction, of an exposure-beam-illumination area on the substrate based on results of the detecting of position information.

According to this, position information, in a normal direction of the surface of the substrate, of at least one point on the flat area of the surface of the substrate is detected, the shape of the flat area being measured using the shape measuring method of this invention, and by illuminating the substrate with the exposure beam while controlling at least a position, in the normal direction, of an exposure-beam-illumination area on the substrate based on results of the detecting of position information, many of the same predetermined pattern are formed on the surface of the substrate. As a result, for example, exposure apparatuses of an imaging optical system can perform exposure with performing auto-focus control accurately and efficiently, thereby being able to perform accurate exposure efficiently.

In the exposure method according to this invention, wherein when illuminating the substrate with the exposure beam, position information, in a normal direction of the surface of the substrate, of a plurality of points on the flat area of the surface of the substrate is detected, and wherein a position in the normal direction of an exposure-beam-illumination area and posture of the substrate are controlled. In this case, for example, exposure apparatuses of an imaging optical system can perform exposure with performing auto-focus leveling control accurately and efficiently.

According to a fourth aspect of this invention, there is provided an exposure apparatus which forms a predetermined pattern on a substrate by illuminating the substrate with an exposure beam, the exposure apparatus comprising: a substrate stage which moves with holding the substrate; a substrate stage drive unit which moves the substrate stage; and a shape measuring unit according to this invention, which employs the substrate stage drive unit as a drive unit.

According to this, a shape measuring unit according to this invention measures accurately the shape of a predetermined area on the surface of a substrate, and exposure is performed based on the shape of the predetermined area accurately measured, thereby being able to perform accurate exposure efficiently. For example, when the predetermined area is an almost flat area coated with a resist, accurate exposure can be performed efficiently.

The exposure apparatus of this invention may further comprise: an imaging optical system which images the predetermined pattern on the substrate, wherein the measuring unit of the shape measuring unit measures deviation relative to a reference point with respect to an optical axis direction of the imaging optical system. In this case, an exposure apparatus comprising a focus-position detection system may use it as the measuring unit.

According to this invention, there is provided a device manufacturing method including a lithography process, wherein in the lithography process, exposure is performed using the exposure method of this invention. According to this, because a predetermined pattern is accurately transferred onto shot areas by exposure using the exposure method of this invention, the productivity of highly integrated devices having a fine pattern thereon can be improved.

### BRIEF DESCRIPTION OF THE DRAWINGS

FIG. 1 is a diagram showing the schematic arrangement of an exposure apparatus according to an embodiment;

FIG. 2 is a plan view showing an arrangement of 45 slit images formed in and around an exposure area IA of a wafer surface;

FIG. 3 is a block diagram showing the structure of the main control system in FIG. 1;

FIG. 4 is a flow chart for explaining the exposure operation of the apparatus in FIG. 1;

FIGS. 5A and 5B are views for explaining the structure of a wafer;

FIGS. 6A and 6B are views for explaining measurement points;

FIG. 7 is a flow chart for explaining the operation of a subroutine for measuring the shape of the wafer in FIG. 5;

FIG. 8 is a view for explaining measurement paths;

FIGS. 9A to 9E are views for explaining a measurement result and processed results;

FIG. 10 is a diagram showing the schematic arrangement of an exposure apparatus as a modified example;

FIG. 11 is a flow chart for explaining a device manufacturing method; and

FIG. 12 is a flow chart showing a process in the wafer-processing step of FIG. 11.

### DESCRIPTION OF THE PREFERRED EMBODIMENT

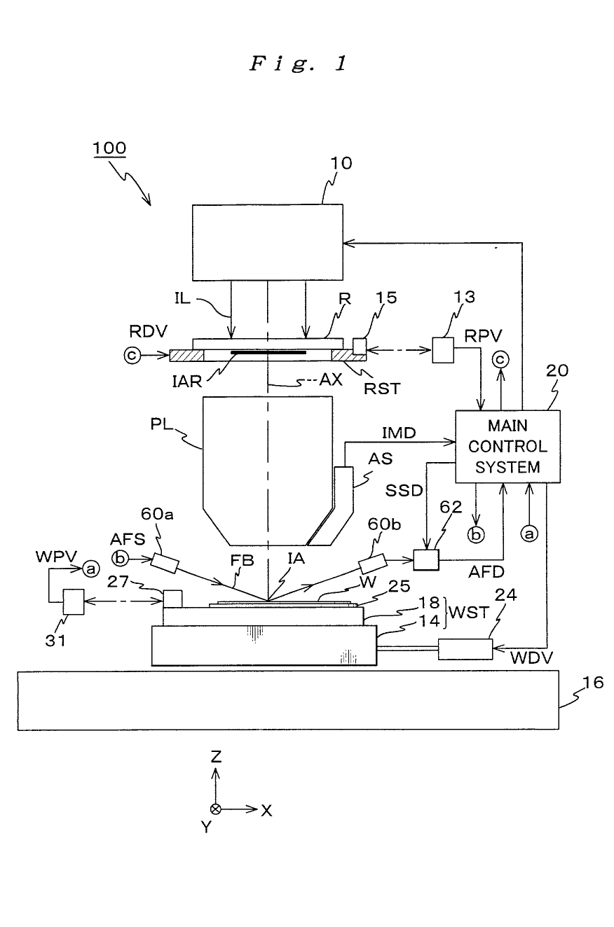

An embodiment of the present invention will be described below with reference to FIGS. 1 through 9. FIG. 1 shows the schematic arrangement of an exposure apparatus 100 according to the embodiment. This exposure apparatus 100 is a scanning exposure apparatus based on the so-called step-and-scan method.

The exposure apparatus 100 comprises an illumination system 10 including a light source and an illumination optical system, a reticle stage RST holding a reticle R as a mask, a projection optical system PL, a wafer stage WST that can freely move on an X-Y plane with holding a wafer W as a substrate (object), and a control system for controlling these components.

The illumination system 10 comprises a light source, an illuminance-uniforming optical system (including a collimator lens and a fly-eye lens), a relay-lens system, a reticle blind and a condenser lens system (none are shown).

In the illumination system 10, after illumination light as exposure beam emitted from the light source has passed through a shutter (not shown), the illuminance uniforming optical system converts the illumination light into a light beam having substantially uniform illuminance distribution, the illumination light being referred to as “illumination light IL” hereinafter. The illumination light IL sent out of the illuminance uniforming optical system passes through the relay-lens system and reaches the reticle blind. The light beam passes through the reticle blind, the relay-lens system, and the condenser lens system in turn, and illuminates an illumination area IAR of the reticle R on which a circuit pattern is drawn with uniform illuminance, which area IAR extends in an X-axis direction and which is shaped like a rectangular slit, having a predetermined width in a Y-axis direction.

On the reticle stage RST, a reticle R is fixed by, for example, vacuum chuck (or electrostatic chuck). The reticle stage RST can be finely driven in two dimensions (the X-axis direction, the Y-axis direction, and rotation (θz) about a Z-axis perpendicular to the X-Y plane) along an X-Y plane perpendicular to the optical axis AX of the projection optical system PL via a reticle-stage-drive portion (not shown) including a linear motor, and can also be moved in the Y-axis direction on a reticle base (not shown) at a specified scan speed. The movement stroke, in the Y-axis direction, of the reticle stage RST is such that the optical axis AX crosses the whole area of the reticle R, or is longer. It is remarked that a main control system 20 controls the movement of the reticle stage RST by supplying a reticle-stage-drive signal RDV to the reticle-stage-drive portion.

Fixed on the reticle stage RST is a movable mirror 15 that reflects a laser beam sent from a reticle laser interferometer 13 (referred to as a “reticle interferometer” hereinafter), and the position of the reticle stage RST in the X-Y plane is detected all the time with a resolving power of, e.g., about 0.5 to 1 nm by the reticle interferometer 13. Although actually a movable mirror having a reflection surface perpendicular to a scan direction (the Y-axis direction) for scan-exposure and a movable mirror having a reflection surface perpendicular to a non-scan direction (the X-axis direction) are provided on the reticle stage RST, and the reticle laser interferometer 13 has X-axis-direction and Y-axis-direction components, in FIG. 1 these are represented by the movable mirror 15 and the reticle interferometer 13.

Position information RPV of the reticle stage RST is sent from the reticle interferometer 13 to the main control system 20 as a controller constituted by a work-station (or a microcomputer), and the main control system 20 drives and controls the reticle stage RST via the reticle-stage-drive portion based on the position information of the reticle stage RST.

The projection optical system PL is disposed below the reticle stage RST in FIG. 1, and the Z-axis direction is set to be parallel to the direction of the optical axis AX. The projection optical system PL is a refraction optical system which is a reduction system that is telecentric on both sides and which is composed of a plurality of lens elements spaced a predetermined distance apart along the optical axis AX, and has a projection ratio of, e.g., ⅕. Therefore, when the slit-shaped illumination area IAR on the reticle R is illuminated with illumination light IL from the illumination system 10, the illumination light IL having passed through the reticle R is projected onto the wafer W via the projection optical system PL, and the reduced image (a partially inverted image) of part of a circuit pattern of the reticle R is formed on an exposure area IA on the wafer W coated with a photo-resist, which area IA is conjugate to the illumination area IAR, the part being present in the slit-shaped illumination area IAR.

The wafer stage WST comprises an X-Y stage 14 driven along the upper surface of a stage base 16 and on an X-Y two-dimensional plane by a wafer-stage-drive portion 24 as a drive unit, a wafer table 18 as a substrate stage mounted on the X-Y stage 14 via a Z-tilt drive mechanism (not shown), and a wafer holder 25 fixed on the wafer table 18. Here, the wafer table 18 holds the wafer W by vacuum chuck or electrostatic chuck. Moreover, the wafer table 18 is constructed to be finely driven in the Z-direction, in a rotation direction about the X-axis (θ_{X}), and in a rotation direction about the Y-axis (θ_{Y}) by the Z-tilt drive mechanism. It is remarked that the main control system 20 controls the movement of the wafer stage WST by supplying a wafer-stage-drive signal WDV to the wafer-stage-drive portion 24.

Fixed on the wafer table 18 is a movable mirror 27 that reflects a laser beam sent from a wafer laser interferometer 31 (referred to as a “wafer interferometer” hereinafter), and the center position of the wafer table 18 (i.e. the wafer stage WST) in the X-Y plane is detected all the time with a resolving power of, e.g., about 0.5 to 1 nm by the wafer interferometer 31.

Here, actually a movable mirror having a reflection surface perpendicular to the scan direction (the Y-axis direction) for scan-exposure and a movable mirror having a reflection surface perpendicular to the non-scan direction (the X-axis direction) are provided on the wafer table 18; the wafer interferometer 31 has a plurality of axis components for each of the X-axis and Y-axis directions, and not only the X-Y position of the wafer table 18 but also the rotations of the wafer table 18 about the X, Y and Z axes (pitching, rolling and yawing) can be detected. In FIG. 1 these are represented by the movable mirror 27 and the wafer interferometer 31.

Position information (or speed information) of the wafer table 18 (i.e. the wafer stage WST) measured by the wafer interferometer 31 is sent to the main control system 20, and the main control system 20 controls the position in the X-Y plane and the rotations of the wafer stage WST (the X-Y stage 14) about the X, Y and Z axes via the wafer-stage-drive portion 24 based on the position information (or speed information).

Provided on the side face of the projection optical system PL is an off-axis-alignment system AS that detects alignment marks on the wafer W. In this embodiment a FIA (Filed Image Alignment) system using an image processing method is employed as the alignment system AS. This alignment system AS illuminates alignment marks on the wafer W via the illumination optical system with broad-banded light (alignment light) from a light source such as a halogen lamp, and receives the reflected light from the alignment marks through an image optical system by a pick-up device such as CCD. By this, a bright-field image of an alignment mark is formed on the receiving face of the pick-up device. A photoelectric transfer signal corresponding to this bright-field image, that is, a light intensity signal IMD corresponding to the reflection image of the alignment mark is sent from the pick-up device to the main control system 20. Based on the light intensity signal IMD the main control system 20 calculates the position of the alignment mark relative to the detection center of the alignment system AS, and based on the calculation results and the corresponding position information of the wafer stage WST that is outputted by the wafer interferometer 31, calculates the coordinate position of the alignment mark in the stage coordinate system defined by the optical axis of the wafer interferometer 31.

Furthermore, the exposure apparatus 100, as illustrated in FIG. 1, is provided with a multi-focal position detection system of an obliquely-incident-light method comprising a light source that a control signal AFS from the main control system 20 switches on and off, an illumination optical system 60a for sending out an imaging beams FB, which forms the images of a number of pin holes or slits on the imaging plane of the projection optical system PL, in a direction at an angle to the optical axis AX, and a light-receiving optical system 60b for receiving these imaging beams reflected by the surface of the wafer W, the multi-focal position detection system being a measurement unit. As the multi-focal position detection system (60a, 60b) of this embodiment, one having the same structure as disclosed in, for example, Japanese Patent Laid-Open No. 6-283403 and U.S. Pat. No. 5,448,332 corresponding thereto is used. The disclosure in the above Japanese Patent Laid-Open and U.S. Patent Application is incorporated herein by reference.

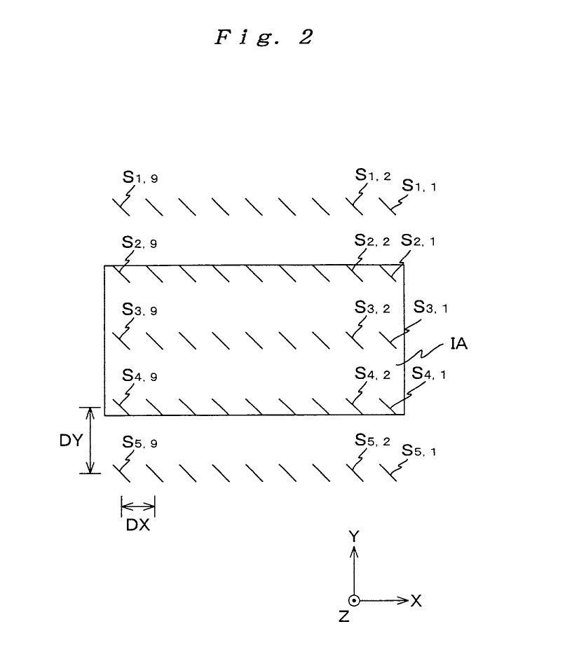

In this case, on a pattern-forming plate (not shown) forming a part of the illumination optical system 60a, 45 slit-shaped openings are formed in the arrangement of a matrix having 5 rows and 9 columns. Therefore, upon scan exposure described later, in and around the rectangular exposure area IA on the surface of the wafer W, 45 (=5×9) images (slit images) S_{1,1} to S_{5,9} of slit-shaped openings that each enclose an angle of 45 degrees with the X-axis and Y axis individually, as shown in FIG. 2, are formed in the arrangement of a matrix having 5 rows and 9 columns and spaced a distance DX (e.g. 2.5 mm) apart in the X-axis direction and a distance DY (e.g. 4 mm) apart in the Y-axis direction. It is noted that the slit image S_{3,5} is formed substantially at the center of the exposure area IA.

Moreover, a light-receiving device (not shown) constituting the light-receiving optical system 60b comprises a light-receiving-slit plate on which 45 slits are formed in the arrangement of a matrix having 5 rows and 9 columns; and 45 photo-sensors that are arranged in the arrangement of a matrix having 5 rows and 9 columns and that correspond to the respective slits, the photo-sensors being referred to as “photo-sensors D_{1,1} to D_{5,9}” for the sake of convenience. When the slit images S_{1,1} to S_{5,9} in FIG. 2 are imaged again on the respective slits of the light-receiving-slit plate, the imaging light beams of the slit images are received by the photo-sensors D_{1,1} to D_{5,9} respectively. In this case, in the light receiving optical system 60b a vibration plate is provided so as to vibrate the images formed on the light-receiving-slit plate in the direction perpendicular to the longitudinal direction of the slits, and a signal-selection-processing unit 62 demodulates synchronously and selectively the respective detection signals from the photo-sensors D_{1,1} to D_{5,9}, using the vibration frequency. And a predetermined number of focus signals AFD that the signal-selection-processing unit 62 has obtained by the synchronous demodulation are supplied to the main control system 20. It is noted that the main control system 20 instructs the signal-selection-processing unit 62 which photo-sensor's signal to select, using a sensor-selection-instructing signal SSD.

As obvious in the above description, in this embodiment the slit images S_{1,1} to S_{5,9}, which are detection points on the wafer W, correspond to the photo-sensors D_{1,1} to D_{5,9} respectively, and because information (focus information) of position, along the Z-axis, of the wafer surface at each slit image is obtained based on a defocus signal from each photo-sensor D, the slit images S_{1,1} to S_{5,9} are referred to as focus sensors, hereinafter for the sake of convenience as long as another need does not arise.

Upon scan exposure described later or the like, the main control system 20 performs auto-focus and auto-leveling by, based on a focus deviation signal (or a defocus signal, e.g. an S-curve signal) from the light receiving optical system 60b, controlling the Z-position, pitching amount (θ_{X} rotation amount) and rolling amount (θ_{Y} rotation amount) of the wafer stage WST via the wafer-stage-drive portion (not shown) so that the focus deviation becomes zero.

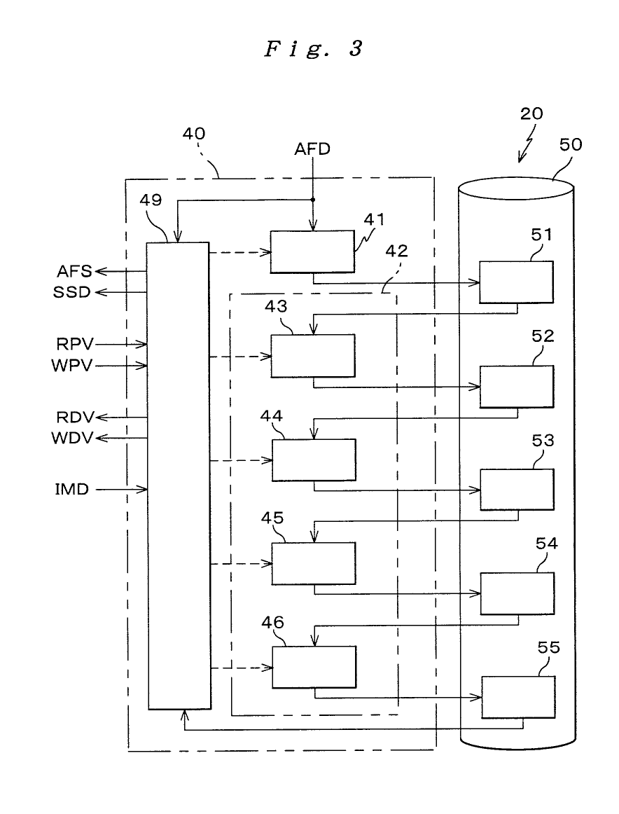

As shown in FIG. 3, the main control system 20 comprises a main controller 40 and a memory unit 50. The main controller 40 comprises (a) a controller 49 for controlling all operations of the exposure apparatus 100, including the moving of the reticle stage RST and the wafer stage WST via the reticle-stage-drive portion and the wafer-stage-drive portion 24, based on the position information (speed information) RPV of a reticle R and the position information (speed information) WPV of a wafer W, (b) a focus-signal-collecting unit 41 for collecting the focus signals AFD from the signal-selection-processing unit 62, and (c) a signal processing unit 42 for determining the shape of a flat area (hereinafter, referred to as a “resist-flat area”) of the resist coating the wafer surface based on the focus signals collected.

Here, the signal processing unit 42 comprises (i) a low-pass-filtering computing unit 43 for filtering the focus signals collected in a low-passed manner, (ii) a differential computing unit 44 for differentiating the focus signals filtered (hereinafter, referred to as “filtered signals”), (iii) an edge-position detection unit 45 for determining the outer edge positions of the resist-flat area based on the filtered signals differentiated (hereinafter, referred to as “differential signals”), and (iv) a shape-parameter calculation unit 46 for calculating the value of a shape parameter defining the shape of the resist-flat area based on the outer edge positions of the resist-flat area.

The memory unit 50 comprises a focus-signal data store area 51, a filtering-signal data store area 52, a differential-signal data store area 53, an edge-position data store area 54 and a shape-parameter-value store area 55. It is noted that in FIG. 3, solid arrow lines denote the flows of data and that dashed arrow lines denote the flows of control. The actions of the components of the main control system 20 will be described later.

Although in this embodiment the main controller 40 comprises the various components, the main control system 20 may be a computer system of which the programs perform the functions, described later, of the various components of the main controller 40.

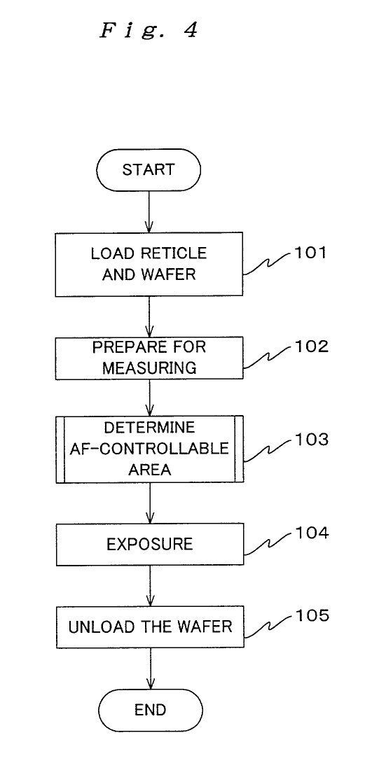

Next, the exposure operation of the exposure apparatus 100 of this embodiment will be described referring mainly to FIG. 4 and to other drawings as needed.

First, in a step 101 of FIG. 4, a reticle loader (not shown) loads a reticle R having a pattern formed thereon onto the reticle stage RST, and a wafer loader (not shown) loads a wafer W subject to exposure onto the substrate table 18.

Then in a step 102, exposure preparation measurement, described later, of the wafer W's surface other than the shape measurement of the resist-flat area is performed under the control of the controller 59. That is, reticle alignment is performed using a reference mark plate (not shown) disposed on the substrate table 18 and base-line amount is measured using the alignment system AS.

In addition, a rough alignment system (not shown) measures the shape of the wafer W to detect the center position and the rotation, about the Z-axis, of the wafer W, and obtains the difference (ΔX, ΔY) between the center position of the wafer W and the center of the wafer stage WST.

If the exposure is for a second or later layer of the wafer W, positional relation between a reference coordinate system defining the movement of the wafer W, i.e. the wafer stage WST, and an arrangement coordinate system concerning the arrangement of shot areas on the wafer W is accurately detected using the alignment system AS based on the above measurement results of the wafer W's shape so as to form a pattern accurately aligned with respect to a pattern of layers already formed.

Next, in a subroutine 103 the shape of the resist-flat area (auto-focus (AF) controllable area) on the wafer is measured.

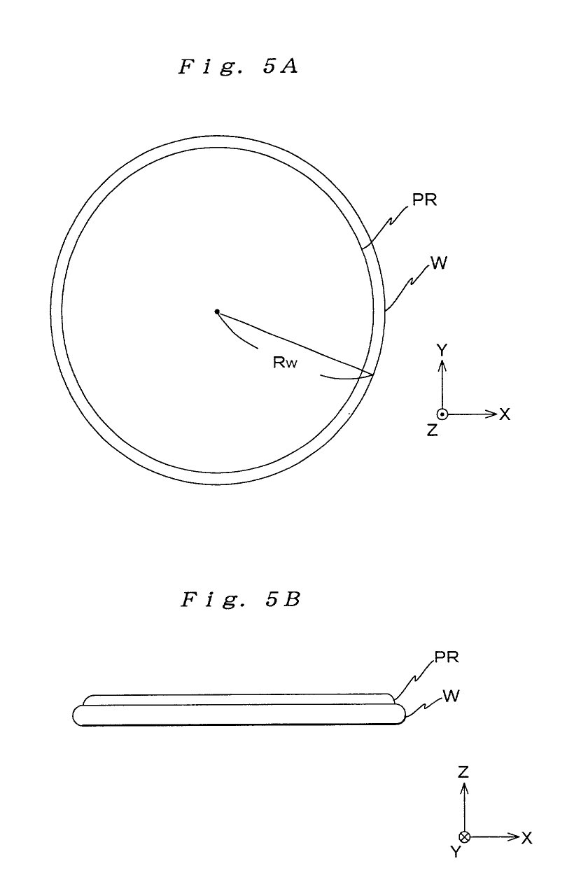

As a premise it is assumed that, as shown in FIGS. 5A and 5B, the wafer W is substantially circular with the radius R_{W} and that a resist layer PR is formed on the surface thereof. This resist layer PR is formed by, e.g., spin-coating with resist material, and near the outer edge of the wafer the resist material has been removed by rinsing. Here, although the surface of the resist layer PR is almost flat, the area near the outer edge (hereinafter, referred to as an “rinsed edge”) of the resist layer PR is inferior to the other surface area in flatness. Here, it is assumed that surface irregularity in the area near the rinsed edge is far smaller than the drop of the rinsed edge in size.

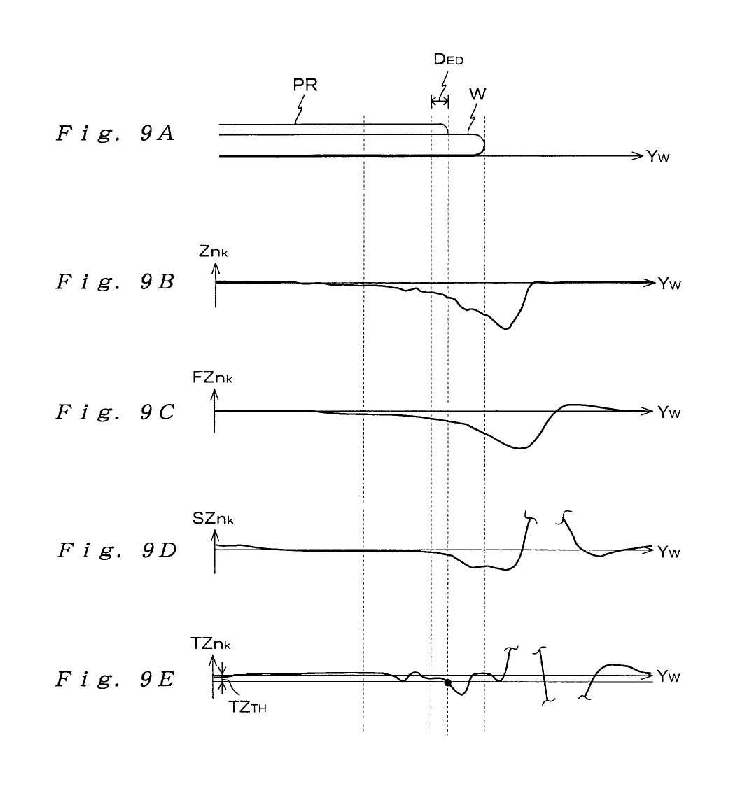

Furthermore, it is assumed that a predetermined distance D_{ED} inward than the rinsed edge or further inward (refer to FIG. 9), the flatness of the surface of the resist layer PR is considerably high. In the subroutine 103, four positions of the rinsed edge are detected, and based on the detection results, the radius R_{D} of the maximum circle out of circles inside which the flatness is ensured and of which the centers coincide with the wafer W's center is obtained which specifies the shape of the resist-flat area.

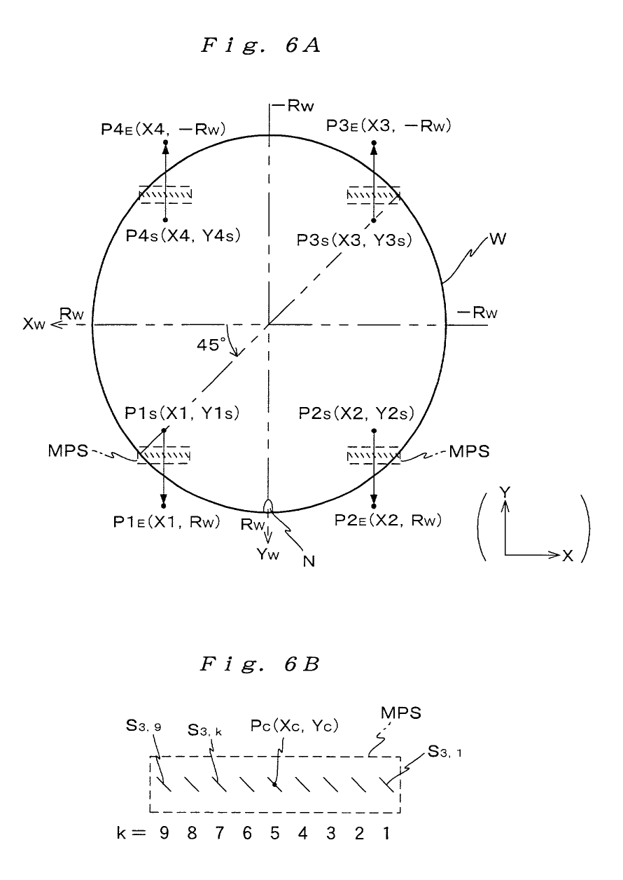

In this embodiment, measurement positions of the rinsed edge, as shown in FIG. 6A, are left bottom (n=1), right bottom (n=2), right top (n=3), and left top (n=4). And as shown in FIG. 6B, positions of the rinsed edge are detected using a group MPS of nine focus sensors S_{3,1} to S_{3,9} of the multi-focal position detection system (60a, 60b).

Here, a wafer coordinate system (X_{W}Y_{W} coordinate system) is considered of which the origin is the center of the wafer W and which has an X_{W} direction opposite to the X-direction and a Y_{W} direction opposite to the Y-direction. When in the X_{W}Y_{W} coordinate system, the position of the focus sensor S_{3,5}, which is in the middle of the sensor group MPS, is denoted by (X_{C}, Y_{C}), the position of a focus sensor S_{3,k} (k=1 through 9) is denoted by (X_{C}+(k−5)×DX, Y_{C}). Hereinafter, (X_{C}, Y_{C}) which denotes the position of the focus sensor S_{3,5}, is also referred to as the position of the sensor group MPS. Here, when the center position of the wafer stage WST is denoted by (X_{S}, Y_{S}) in the wafer-stage coordinate system (XY coordinate system) defined by measurement axes of the wafer interferometer 31, the following equations hold true.

X_{C}=X_{S}+ΔX,Y_{C}=Y_{S}+ΔY

That is, correcting measurement results of the wafer interferometer 31 by the difference (ΔX, ΔY) between the center position of the wafer W and the center of the wafer stage WST obtained by the rough alignment measurement give the position, in the X_{W}Y_{W} coordinate system, of the sensor group MPS and thus the position of the focus sensor S_{3,k}. Hereinafter, the positions of the sensor group MPS and the focus sensor S_{3,k} mean positions in the X_{W}Y_{W} coordinate system unless specified otherwise.

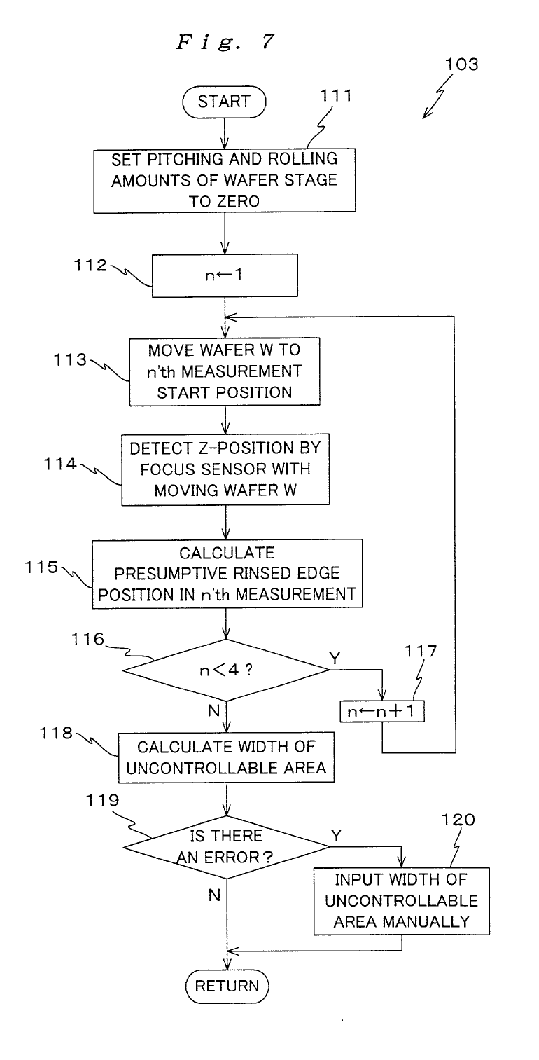

First in a step 111 of the subroutine 103, as shown in FIG. 7, both the pitching amount and rolling amount of the wafer stage WST are set to zero. The setting of the pitching amount and rolling amount of the wafer stage WST is performed by the main control system 20 (more specifically the controller 49) via the wafer-stage-drive portion 24 based on position information (speed information) from the wafer interferometer 31.

Next, in a step 112 the measurement position parameter n is set to one.

Then in a step 113 the wafer W is moved such that the position of the sensor group MPS (X_{C}, Y_{C}) coincides with a first measurement start position (X1, Y1_{S}). The measurement start position (X1, Y1_{S}), as shown in FIG. 6A, is such a position on the wafer W that all focus sensors S_{3,k} fall in the inner area of the wafer W, which is described later. The main control system 20 moves the wafer stage WST and thus the wafer W via the wafer-stage-drive portion 24 based on position information (speed information) from the wafer interferometer 31.

Referring back to FIG. 7, subsequently in a step 114, the focus sensors S_{3,k} are relatively moved in the +Y_{W} direction and to a measurement-completion position outside the wafer W by moving the wafer W in the +Y direction. In this movement, auto-focus-leveling control is not performed; the wafer W is first accelerated and then controlled to move at constant speed. The measurement start position (X1, Y1_{S}), acceleration and constant speed are set so as to ensure that, when the wafer starts to move at constant speed, all focus sensors S_{3,k} are still in the flat area of the resist layer PR. Here, the radius of a circle, inside the flat area of the resist layer PR, of which the center coincides with the wafer center and which contains all focus sensors S_{3,k} when the wafer starts to move at constant speed is denoted by R_{T}.

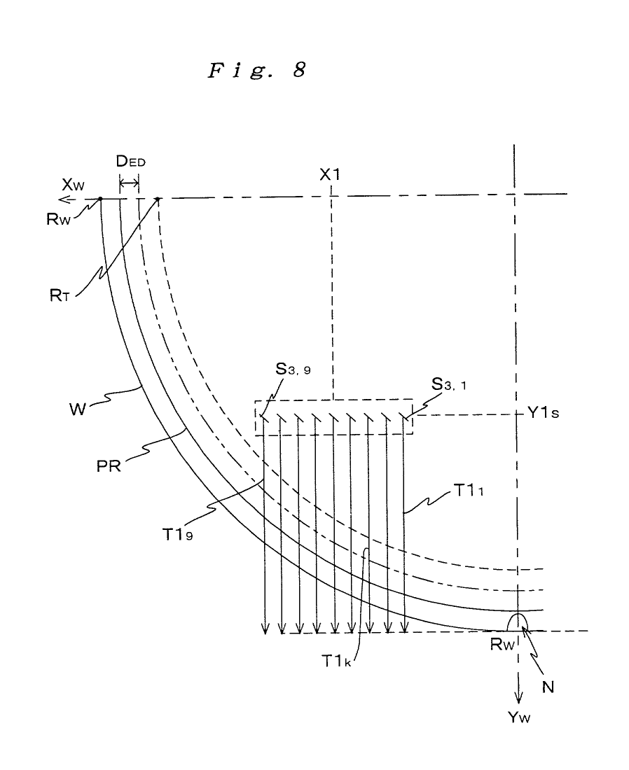

When the wafer W moves in +Y direction in the manner described above, each focus sensor S_{3,k} follows a line trace T1ₖ as shown in FIG. 8. In FIG. 8, the distance between a position on the path T1₉ of the focus sensor closest, in the X_{W} direction, to the wafer edge (focus sensor S_{3,9}) and the wafer center is denoted by R_{T}, in which position the wafer moves at constant speed, and a circle having the radius R_{T} is drawn by a dashed line.

And the focus sensor S_{3,k} detects Z-position Z1ₖ(Y_{W}) at each position on the line trace T1ₖ. The Z-positions Z1ₖ(Y_{W}) detected are sent from the signal-selection-processing unit 62 to the main control system 20, the Z-positions representing a focus-position signal AFD. The focus-signal-collecting unit 41 of the main control system 20 receives and stores the focus-position signal AFD in focus-signal data store area 51. The Z-position Z1ₖ(Y_{W}) contained in the focus signal AFD varies according to position Y_{W} as illustrated in FIG. 9B that is corresponding to the outer edge of the wafer W and rinsed edge of the resist layer in FIG. 9A.

Referring back to FIG. 7, in a next step 115 a rinsed-edge position (radius) is calculated for each trace T1ₖ. In this calculation, first the low-pass-filtering computing unit 43 performs low-pass-filtering processing of a focus-position signal read out by the focus-signal-collecting unit 41, using a specified cut-off frequency f_{C}. The waveform of a filtered signal FZ1ₖ(Y_{W}) obtained in this way is shown in FIG. 9C. The low-pass-filtering computing unit 43 stores the filtered signal FZ1ₖ(Y_{W}) in the filtering-signal data store area 52.

Subsequently, the differential computing unit 44 reads out the filtered signal FZ1ₖ(Y_{W}) from the filtering-signal data store area 52 and performs first-order differential processing thereof and then second-order differential processing. The waveforms of the first-order differential signal SZ1ₖ(Y_{W}) and second-order differential signal TZ1ₖ(Y_{W}) obtained in this way are shown in FIGS. 9D and 9E respectively. The differential computing unit 44 stores the second-order differential signal TZ1ₖ(Y_{W}) in the differential-signal data store area 53.

Next, the edge-position detection unit 45 reads out the second-order differential signal TZ1ₖ(Y_{W}) from the differential-signal data store area 53 and calculates a presumptive rinsed-edge position (X1+(k−5)×DX, YE1ₖ) for the trace T1ₖ, using a value TZ_{TH} obtained experimentally beforehand. Here, the edge-position detection unit 45 obtains a Y-point YE1ₖ which is one of Y-positions in which the values of the second-order differential signal TZ1ₖ(Y_{W}) are equal to the value TZ_{TH}, which is outside the circle having the radius R_{T} and which is closest to the circle. Incidentally, the reason why the second-order differential signal TZ1ₖ(Y_{W}) is used instead of the first-order differential signal SZ1ₖ(Y_{W}) to calculate the presumptive rinsed-edge position is that, if the movement face of the wafer stage WST and the surface of the wafer W become not parallel to each other somehow, the focus signal Z1ₖ(Y_{W}) slopes as a whole, thus causing an offset in the first-order differential signal SZ1ₖ(Y_{W}). Therefore, the second-order differential signal TZ1ₖ(Y_{W}) of which an offset never occurs is used to calculate the presumptive rinsed-edge position.

Subsequently, the edge-position detection unit 45 calculates the radius E1ₖ of a rinsed-edge circle base on a presumptive rinsed-edge position (X1+(k−5)×DX, YE1ₖ) for each trace T1ₖ using the following equation (1).

RE1ₖ=((X1+(k−5)×DX)²+(YE1ₖ)²)^{½} (1)

Then the edge-position detection unit 45 stores the obtained radii RE1ₖ in the edge-position data store area 54.

Referring back to FIG. 7, a step 116 checks whether or not n<4, that is, radii REnₖ (n=1 through 4) have been obtained for all measurement points. Here, because n=1 and only radii RE1ₖ for the first measurement point have been obtained, the answer is YES, and the sequence proceeds to a step 117.

In the step 117, n is incremented (n←n+1), and the sequence proceeds to the step 113.

After that, in the same way as the above, radii RE2ₖ, radii RE3ₖ, and radii RE4ₖ are obtained in turn and stored in the edge-position data store area 54. The reason for measuring at four points is that although focus signals Znₖ(Y_{W}) are to be in the same shape at measurement position n=1 and position n=2, for each ‘k’, and also at measurement position n=3 and position n=4 because of symmetry when considering the shape of the slit-shaped illumination areas, on the wafer, of the focus-position detection beams, the focus signals Znₖ(Y_{W}) are quite different in reality.

In this manner, after all radii REnₖ for the four measurement positions are obtained, the answer in the step 116 is NO, and the sequence proceeds to a step 118.

In the step 118, the shape-parameter calculation unit 46 reads out the radii REnₖ (n=1 through 4) from the edge-position data store area 54 and calculates the radius R_{D} of the resist-flat area. When calculating the radius R_{D}, first the shape-parameter calculation unit 46 checks, for each measurement position (each value of n), whether or not a radius REnₖ satisfying the following equation (2) is present.

|REnₖ31 MRAn|>α (2),

where MRAn represents the median of nine radii REnₖ and α is a predetermined value.

When a radius REnₖ satisfying the equation (2) is present, the shape-parameter calculation unit 46 calculates the average REn of radii REnⱼ except for the radius REnₖ for each measurement position. Incidentally, the reason for excluding the radius REnₖ whose value is α apart from the MREn and calculating an average instead of calculating the average of nine radii REnₖ is that the measurement conditions of all the nine focus sensors S_{3,1} to S_{3,9} are not necessarily optimal, thus causing some radii greatly different from the others and that such radii need to be excluded from the calculation of the average REn.

Subsequently, in a step 119 the shape-parameter calculation unit 46 checks whether or not there is a large dispersion in the four REn (n=1 through 4) obtained, using the following inequality.

Max(REn)−Min(REn)>β (3),

where β is a predetermined value. If the answer is No, the shape-parameter calculation unit 46 calculates the average RE of the four REn as the rinsed-edge radius, and the radius R_{D} of the resist-flat area is obtained using the following equation (4).

R_{D}=RE−D_{ED} (4),

where D_{ED} is the width, on design, of the area, which is near the rinsed-edge and inferior in flatness, plus a margin.

And the shape-parameter calculation unit 46 calculates a width D_{D} within which auto-focus-leveling cannot be controlled, using the following equation (5).

D_{D}=R_{W}−R_{D} (5)

The shape-parameter calculation unit 46 stores the uncontrollable-area width D_{D} obtained in the shape-parameter-value store area 55.

Meanwhile, in the step 119 if the answer is YES, the sequence proceeds to a step 120, and the shape-parameter calculation unit 46 displays an error message, urges an operator to input a value for the uncontrollable-area width D_{D}, and when a value has been inputted, stores the value for the width D_{D} of the uncontrollable area in the shape-parameter-value store area 55.

After the completion of determining the uncontrollable-area width D_{D} (completion of the subroutine 103), the sequence proceeds to a step 104 in FIG. 4.

In the step 104 exposure of the wafer W is performed. Upon exposure, first, the substrate table 18 is moved so as to move a first shot area on the wafer W to a scan-start position for exposure. The main control system 20 controls this movement via the wafer-stage-drive portion 24 based on position information (speed information) from the wafer interferometer 31 and, for exposure for the second or later layer, based on detection results of positional relation between the reference coordinate system and the arrangement coordinate system as well. At the same time, the main control system 20 moves the reticle stage RST so as to move the X-Y position of the reticle R to a scan-start position via the reticle-stage-drive portion (not shown).

Next, the main control system 20 selects a sensor for auto-focus-leveling control out of sensors whose detection points are present in an auto-focus-controllable area, based on the uncontrollable-area width D_{D}. Subsequently, the main control system 20 performs scan exposure based on the Z-position information detected by the multi-focal position detection system (60a, 60b) and the X-Y position of the reticle R measured by the reticle interferometer 13 and the X-Y position of the wafer W measured by the wafer interferometer 31, with adjusting the position of the wafer w and moving the reticle R and the wafer W relatively via the reticle-stage-drive portion (not shown) and the wafer-stage-drive portion 24.

In this manner, after the completion of exposure of the first shot area, the wafer stage WST is moved so as to move a next shot area to the scan-start position and the reticle stage RST is moved so as to move the X-Y position of the reticle R to the scan-start position for a reticle. Then the scan exposure of the shot area is performed in the same way as of the first shot area. Subsequently, the scan exposure of each of the other shot areas is performed likewise.

And in a step 105, the wafer loader (not shown) unloads the wafer W from the wafer stage WST, and the exposure operation for the wafer W is completed.

After that, with measuring the uncontrollable-area width D_{D} for each wafer, each lot, or for each manufacturing process as needed, exposure of a lot of wafers is performed.

As described above, according to this embodiment, positions, along the Z-direction, of the surface of a wafer W are measured along a plurality of paths extending outward from a plurality of points on the wafer W's surface, and for each path, a rinsed-edge position where a large drop occurs is detected. As a result, the shape of a rinsed edge is accurately and automatically measured.

Moreover, because of processing in a low-pass-filtered manner signals of positions, along the Z-direction of the wafer W's surface, measured along the plurality of paths to detect rinsed-edge positions, high-frequency noise can be rejected, thus being able to accurately detect the rinsed-edge positions.

Furthermore, because of differentiating filtered signals into which the signals of the positions, along the Z-direction of the wafer W's surface, measured along the plurality of paths are processed in a low-pass-filtered manner to detect rinsed-edge positions, the drops and thus the rinsed-edge positions can be accurately detected.

Furthermore, because of using second-order differential signals formed by second-order differential processing to detect rinsed-edge positions, offsets due to the slope of the wafer W do not occur and thus the rinsed-edge positions can be accurately detected.

Because of calculating the auto-focus-leveling-controllable area based on the shape of a rinsed edge accurately detected, the precise range of the auto-focus-leveling-controllable area can be found.

Moreover, because exposure is performed with detecting focus positions within the range of the auto-focus-leveling-controllable area obtained, a pattern on the reticle R is accurately transferred onto the wafer W.

Furthermore, because the range of the auto-focus-leveling-controllable area is obtained using the multi-focal position detection system (60a, 60b) for auto-focus-leveling control, a major change of the existing apparatus's structure is not needed.

Incidentally, although the above embodiment uses the multi-focal position detection system (60a, 60b) to detect rinsed-edge positions on a wafer, a different sensor may be used for detecting rinsed-edge positions.

Furthermore, although the above embodiment detects rinsed-edge positions on a wafer surface, the outer edge positions of the wafer may be detected, or both the rinsed-edge positions and the outer edge positions may be detected.

Moreover, although the above embodiment uses the nine sensors at the same time to detect rinsed-edge positions, any number of sensors may be used. For example, rinsed-edge positions for a plurality of paths may be sequentially detected using one sensor.

In addition, to accurately measure rinsed-edge positions, the cut-off frequency f_{C}, the value TZ_{TH}, and α, β need be set to appropriate values. Therefore, an assist-mode, where an operator can set these values and confirm the measurement results, is preferably provided as well as auto-measurement.

Furthermore, in the above embodiment values TZ_{TH} of all measurement positions are the same. However, a different value may be used for each measurement position.

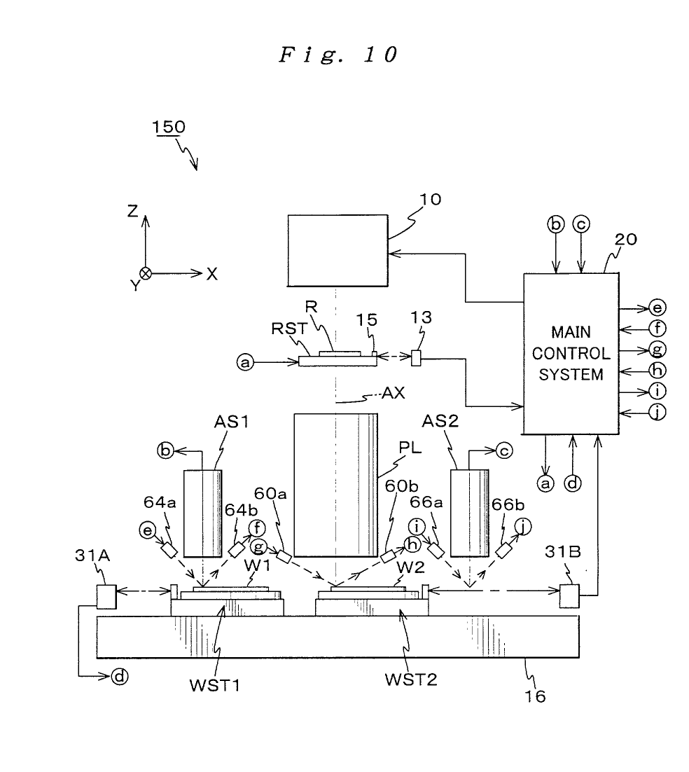

In addition, although the exposure apparatus of the above embodiment employs one wafer stage WST, this invention can be applied to exposure apparatuses comprising two wafer stages WST1, WST2, such as an exposure apparatus 150 in FIG. 10, which can move in two dimensions independently of each other. In a description of the exposure apparatus 150 in the below, the same symbols are attached to components that are the same as or equivalent to those of the exposure apparatus 100, and explanations will be omitted to avoid repetition.

As shown in FIG. 10, compared to the exposure apparatus 100, the exposure apparatus 150 is characterized by (a) alignment systems AS1, AS2 that are disposed the same distance apart from the projection optical system PL on each side, (b) a multi-focal position detection system (64a, 64b) for the alignment system AS1 and (c) a multi-focal position detection system (66a, 66b) for the alignment system AS2. The exposure apparatus 150 further comprises (d) wafer interferometers 31A, 31B each sending out an interferometer beam to an X-movable mirror of the wafer stage WST1, WST2. The other parts have the same structure as those of the exposure apparatus 100.

In the exposure apparatus 150 the above sequential scan exposure of shot areas of one wafer and the above fine alignment and shape measurement of the other wafer can be performed in parallel, the wafers being mounted on the wafer stages WST1, WST2 which can move in two dimensions independently of each other. That is, while the multi-focal position detection system (60a, 60b) performs auto-focus-leveling control, fine alignment by the alignment system AS1 or AS2 and shape measurement of the focus-controllable area (the resist-flat area) by the multi-focal position detection system (64a, 64b) or (66a, 66b) can be performed. As a result, exposure accuracy and throughput can be improved.

The present invention can be applied not only to exposure apparatuses for manufacturing semiconductor devices but also to exposure apparatuses for transferring a device pattern onto a glass plate in the manufacture of displays such as liquid crystal display devices and plasma displays, exposure apparatuses for transferring a device pattern onto a ceramic plate in the manufacture of thin magnetic heads, and exposure apparatuses for the manufacture of pick-up devices (CCD, etc.).

Moreover, the present invention can be applied not only to exposure apparatuses for manufacturing micro devices such as semiconductor devices but also to exposure apparatuses for transferring a circuit pattern onto a glass substrate or silicon wafer so as to produce a reticle or mask used by a light exposure apparatus, EUV (Extreme Ultraviolet) exposure apparatus, X-ray exposure apparatus, electron beam exposure apparatus, or the like.

Furthermore, the present invention can be applied not only to exposure apparatuses but also to other processing units such as a laser-repair unit and a substrate-inspection unit or shape measurement of samples in other precision apparatuses.

Moreover, the exposure apparatuses of the present invention can use not only a projection optical system but also an X-ray optical system or a charged-particle beam optical system such as an electron optical system. For example, when using an electron optical system, the optical system may comprise an electron lens and deflector, and lanthanum-hexaboron (LaB₆) or tantalum (Ta), which is of a thermionic-emission type, may be employed in the electron gun. Incidentally, the optical path of the electron beam needs to be in a vacuum. Also the exposure apparatuses of the present invention can employ not only far ultraviolet light or vacuum ultraviolet light but also EUV light having a wavelength of about 5 to 30 nm, the range of soft X-ray.

Moreover, although usually ArF excimer laser light, F₂ laser light, etc., are employed as vacuum ultraviolet light, a higher-harmonic wave may be employed which is obtained by wavelength conversion into ultraviolet using a non-linear optical crystal after amplifying single wavelength laser light, infrared or visible, emitted from a DFB semiconductor laser device or a fiber laser by a fiber amplifier having, for example, erbium (or both erbium and ytterbium) doped.

Moreover, although the above embodiment describes the case where a reduction system is employed as the projection optical system, an equal-size or magnification system may be employed.

Incidentally, the exposure apparatuses of the embodiment, e.g. the exposure apparatus 100, can be made in the following manner. The illumination optical system and the projection optical system, which each are composed of a plurality of lenses, are built in the exposure-apparatus main body, and optical adjustment is performed thereon; the multi-focal position detection system, the wafer stage, the reticle stage, and other components are assembled and connected mechanically and electrically, and then overall adjustment (electrical adjustment, operation check and the like) is performed. Furthermore, the exposure apparatuses are preferably made in a clean room where temperature, cleanness and the like are controlled.

Next, the manufacture of devices by using the above exposure apparatus and method will be described.

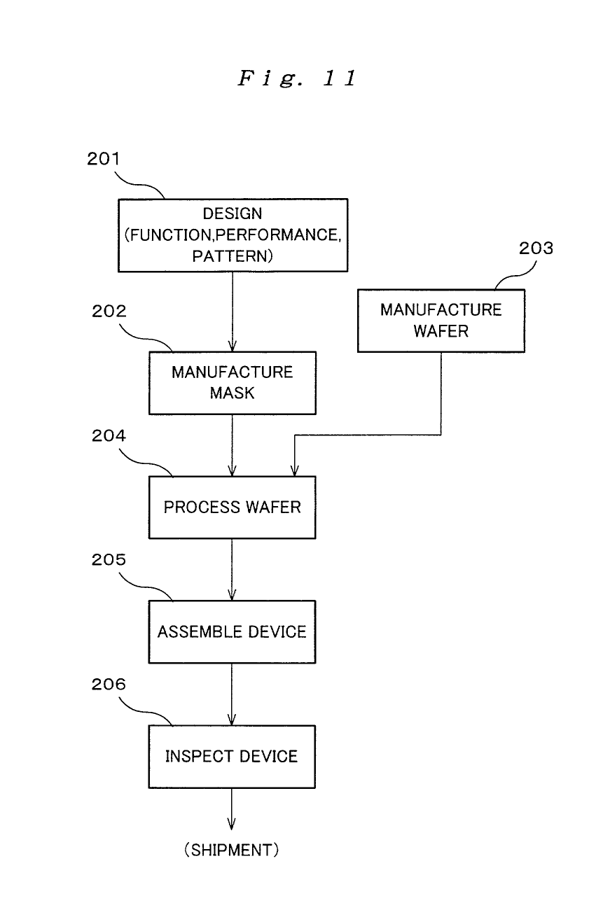

FIG. 11 is a flow chart for the manufacture of devices (semiconductor chips such as IC or LSI, liquid crystal panels, CCD's, thin magnetic heads, micro machines, or the like) in this embodiment. As shown in FIG. 11, in step 201 (design step), function/performance design for the devices (e.g., circuit design for semiconductor devices) is performed and pattern design is performed to implement the function. In step 202 (mask manufacturing step), masks on which a different sub-pattern of the designed circuit is formed are produced. In step 203 (wafer manufacturing step), wafers are manufactured by using silicon material or the like.

In step 204 (wafer processing step), actual circuits and the like are formed on the wafers by lithography or the like using the masks and the wafers prepared in steps 201 through 203, as will be described later. In step 205 (device assembly step), the devices are assembled from the wafers processed in step 204. Step 205 includes processes such as dicing, bonding, and packaging (chip encapsulation).

Finally, in step 206 (inspection step), a test on the operation of each of the devices, durability test, and the like are performed. After these steps, the process ends and the devices are shipped out.

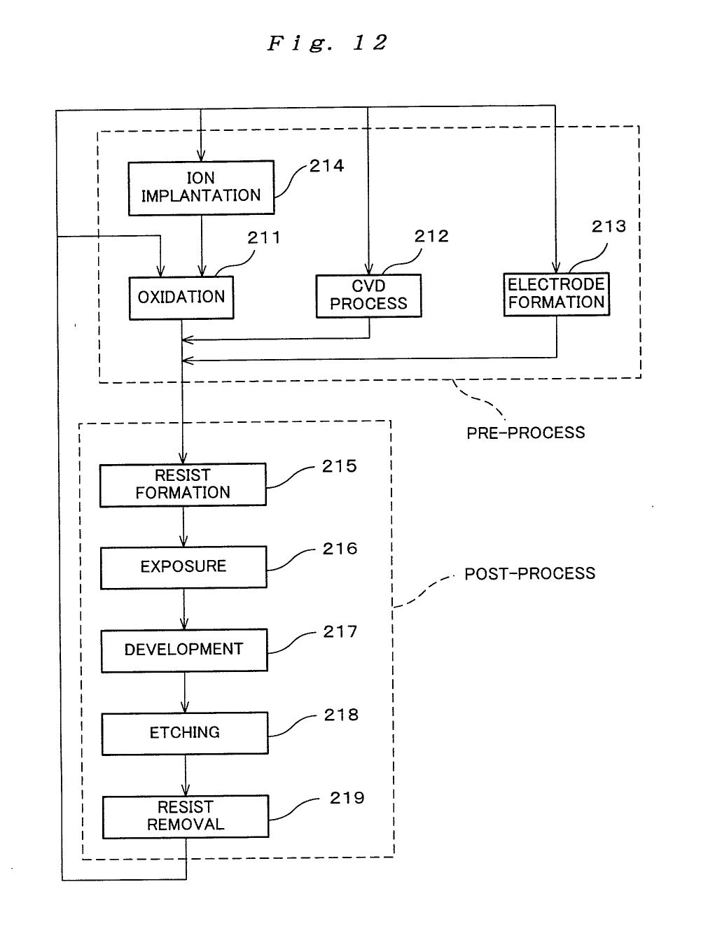

FIG. 12 is a flow chart showing a detailed example of step 204 described above in manufacturing semiconductor devices. Referring to FIG. 12, in step 211 (oxidation step), the surface of a wafer is oxidized. In step 212 (CVD step), an insulating film is formed on the wafer surface. In step 213 (electrode formation step), electrodes are formed on the wafer by vapor deposition. In step 214 (ion implantation step), ions are implanted into the wafer. Steps 211 through 214 described above constitute a pre-process for each step in the wafer process and are selectively executed in accordance with the processing required in each step.

When the above pre-process is completed in each step in the wafer process, a post-process is executed as follows. In this post-process, first of all, in step 215 (resist formation step), the wafer is coated with a photosensitive material (resist). In step 216, the above exposure apparatus transfers a sub-pattern of the circuit on a mask onto the wafer according to the above method. In step 217 (development step), the exposed wafer is developed. In step 218 (etching step), an exposing member on portions other than portions on which the resist is left is removed by etching. In step 219 (resist removing step), the unnecessary resist after the etching is removed.

By repeatedly performing these pre-process and post-process, a multiple-layer circuit pattern is formed on each shot-area of the wafer.

In the above manner, the devices on which a fine pattern is accurately formed are manufactured.

Although the embodiments according to the present invention are preferred embodiments, those skilled in the art of lithography systems can readily think of numerous additions, modifications and substitutions to the above embodiments, without departing from the scope and spirit of this invention. It is contemplated that any such additions, modifications and substitutions will fall within the scope of the present invention, which is defined by the claims appended hereto.

What is claimed is:

1. A shape measuring method with which to measure a shape of a predetermined area on a surface of an object, the shape measuring method comprising:
measuring position information, in a normal direction of the surface of the object, of the surface of the object along a plurality of paths which extend from a plurality of respective points on the surface of the object outward from the object; and
calculating the shape of the predetermined area based on measurement results of the measuring.

2. A shape measuring method according to claim 1, wherein each of the plurality of paths is a straight line.

3. A shape measuring method according to claim 1, wherein the calculating of the shape comprises performing low-pass-filtering processing on each of waveforms which are measured along the plurality of paths in order to extract a low-frequency component.

4. A shape measuring method according to claim 3, wherein the calculating of the shape further comprises performing differential processing on each of waveforms which are formed by the low-pass-filtering processing.

5. A shape measuring method according to claim 4, wherein the differential processing is second-order differential processing.

6. A shape measuring method according to claim 1, wherein the calculating of the shape comprises performing differential processing on each of waveforms which are measured along the plurality of paths.

7. A shape measuring method according to claim 6, wherein the differential processing is second-order differential processing.

8. A shape measuring method according to claim 1, wherein the object is a substrate of which a surface is coated with photosensitive material so as to form an almost flat layer.

9. A shape measuring method according to claim 8, wherein part of the photosensitive material near an outer edge of the substrate is removed.

10. A shape measuring method according to claim 9, wherein the predetermined area is one of a whole area of the substrate and an area coated with the photosensitive material.

11. A shape measuring unit which measures a shape of a predetermined area on a surface of an object, the shape measuring unit comprising:
a measuring unit which measures position information, in a normal direction of the surface of the object, of at least one point on the surface of the object;
a drive unit which relatively moves the object and the measuring unit along a direction parallel to the surface of the object; and
a processing unit which calculates the shape of the predetermined area based on results of the measuring unit measuring along a plurality of paths, which extend from a plurality of respective points on the surface of the object outward from the object, while the drive unit relatively moves the object and the measuring unit.

12. A shape measuring unit according to claim 9, wherein the object is a substrate of which a surface is coated with photosensitive material so as to form an almost flat layer.

13. An exposure method which forms a predetermined pattern on a substrate by illuminating the substrate with an exposure beam, the exposure method comprising:
measuring a shape of a flat area of a surface of the substrate, using the shape measuring method of claim 8; and
detecting position information, in a normal direction of the surface of the substrate, of at least one point on the flat area of the surface of the substrate, which flat area is obtained from results of the measuring, and illuminating the substrate with the exposure beam while controlling at least a position, in the normal direction, of an exposure-beam-illumination area on the substrate based on results of the detecting of position information.

14. An exposure method according to claim 13, wherein when illuminating the substrate with the exposure beam, position information, in a normal direction of the surface of the substrate, of a plurality of points on the flat area of the surface of the substrate is detected, and wherein a position in the normal direction of an exposure-beam-illumination area and posture of the substrate are controlled.

15. An exposure apparatus which forms a predetermined pattern on a substrate by illuminating the substrate with an exposure beam, the exposure apparatus comprising:
a substrate stage which moves with holding the substrate;
a substrate stage drive unit which moves the substrate stage; and
a shape measuring unit according to claim 12, which employs the substrate stage drive unit as a drive unit.

16. An exposure apparatus according to claim 15, further comprising:
an imaging optical system which images the predetermined pattern on the substrate,
wherein the measuring unit of the shape measuring unit measures deviation relative to a reference point with respect to an optical axis direction of the imaging optical system.

17. A device manufacturing method including a lithography process, wherein in the lithography process, exposure is performed using the exposure method of claim 13.
